(19) United States
(12) Patent Application Publication
(10) Pub. No.: US 2009/0145825 A1
(43) Pub. Date: Jun. 11, 2009

(54) Filter Arrangement for Liquids

(75) Inventors: Markus Kolczyk, Mundelsheim (DE); Marc Dapper-Saalfels, Obersulm (DE)

Correspondence Address: GUDRUN E. HUCKETT DRAUDT, SCHUBERTSTR. 15A, WUPPERTAL, 42289, DE

(73) Assignee: MANN+HUMMEL GMBH, Ludwigsburg (DE)

(21) Appl. No.: 12/065,654

(22) PCT Filed: Jul. 19, 2006
(86) PCT No.: PCT/EP06/64404

§ 371 Date: Mar. 4, 2008

(30) Foreign Application Priority Data
Aug. 4, 2005 (DE) 20 2005 012 435.4

(51) Int. Cl. B01D 35/153; B01D 35/02; F01M 11/03

(52) U.S. Cl. 210/130; 210/429; 210/234; 210/167.08

(57) ABSTRACT

A filter arrangement for liquids has a filter housing with a bottom part and a top part. A cylindrical filter element is inserted axially into the filter housing. At least one seal that, after assembly of the filter arrangement, effects closure of at least one return device for unfiltered liquid to be filtered is provided. The at least one seal is a beak valve arranged in the filter housing, wherein the at least one seal prevents return of unfiltered liquid as well as of filtered liquid of the filter element.

### TECHNICAL FIELD

The invention relates to a filter arrangement for liquids, in particular for oil or fuel of an internal combustion engine, according to the preamble of the independent claim.

### PRIOR ART

Filter elements for liquid filtration of viscous media such as oil or fuel are produced conventionally from pleated filter media, preferably in a cylindrical shape. They are usually replaceable filters that generally are mounted by being connected by means of a threaded connector to the screw head in a filter housing and then provide an axial sealing action. The embodiments with a central tube for receiving the filter elements are often designed such that the mutual sealing action of the unfiltered side and the filtered side in the stream of the media to be filtered is realized by means of an O-ring pushed onto the central tube that can be changed in a servicing situation.

It is known from e.g. DE 100 46 494 A to employ a metal-free filter element in the case of an oil filter for filtering oil of an internal combustion. This filter element is inserted into a housing and the housing is closed off by a lid. For reducing the oil return upon shutdown of the internal combustion engine, usually a non-return check valve is provided in the housing. At least one seal on the filter element is arranged such that the seal rests seal-tightly against a housing wall of the filter housing within a predetermined axial movement range.

DE 41 40 140 A, for example, discloses a further filter arrangement for fuel and/or lubricants of an internal combustion engine in which in addition to a non-return diaphragm for the incoming unfiltered liquid there is also a spring-loaded non-return check valve for the filtered side of the outflowing liquid that prevents emptying of the filter in a non-operating state.

### DISCLOSURE OF THE INVENTION

The filter arrangement according to the invention for liquids is provided in accordance with the filter arrangement of the aforementioned kind with a cylindrical filter element that can be inserted axially into a filter housing wherein the filter element, after assembly, effects closure of at least one return device for the unfiltered liquid to be filter with at least one seal provided in the filter housing. Advantageously, the seal according to the invention is embodied as a beak valve that is secured on the filter element and prevents return flow of the unfiltered liquid as well as of the filtered liquid of the filter element. The liquids to be filtered can be, for example, fuel and/or lubricants for an internal combustion engine of a motor vehicle, or water.

Preferably, the beak valve is an elastomer component that combines the function of the conventional single-part non-return diaphragm with a beak valve in a common component. The beak valve can serve in any respect as a leakage protection for the liquid contained in the filter element. In accordance with the invention, a first part of the elastomer component releases an opening in the flow direction of the incoming unfiltered liquid and with a second part, by means of a predetermined angular arrangement of the sealing flaps of the second part, the outlet is dosed off in the outflow direction of the filtered liquid in case of disassembly and, after mounting, the outlet is released by mechanical action of the filter housing or by the pressure of the filtered liquid.

In a first embodiment, the sealing flaps are angled in the direction counter to the direction of flow of the filtered liquid and, when being mounted, by mechanical action of the filter housing where the filter element is arranged, an opening of the angled arrangement and thus of the beak valve can be effected. The mechanical action can be advantageously effected by means of a screw nipple secured to the bottom part of the filter housing which screw nipple pushes through the seal flaps during assembly. Upon removal of the replaceable filter the beak valve closes again so that leakage of liquid is prevented.

According to another embodiment, the seal flaps are angled in the direction of flow of the filtered liquid and an opening of the angled arrangement and thus of the beak valve is effected by the pressure of the flow of the filtered liquid.

In summarizing the above, it should be noted that for example for an oil filter in a motor vehicle leakage of oil from the replaceable filter upon demounting is prevented. The spring-loaded valves that have been used in the past as non-return check valves at the filtered oil side are no longer needed, and this results in significant cost savings. Both embodiments according to the invention protect thus also the filtered side of the filter from contamination during transport and during mounting.

### BRIEF DESCRIPTION OF THE DRAWINGS

Embodiments of the filter arrangement according to the invention will be explained with the aid of the Figures of the drawing. It is shown in:

FIG. 1 a section of a basic configuration of a filter arrangement for liquids according to the prior art,

FIG. 2 a schematic illustration of the unfiltered side and filtered side of the filter arrangement with the beak valve according to the invention in accordance with a first embodiment; and

FIG. 3 a schematic illustration of the unfiltered side and the filtered side of the filter arrangement with the beak valve according to the invention in accordance with a second embodiment.

### EMBODIMENT(S) OF THE INVENTION

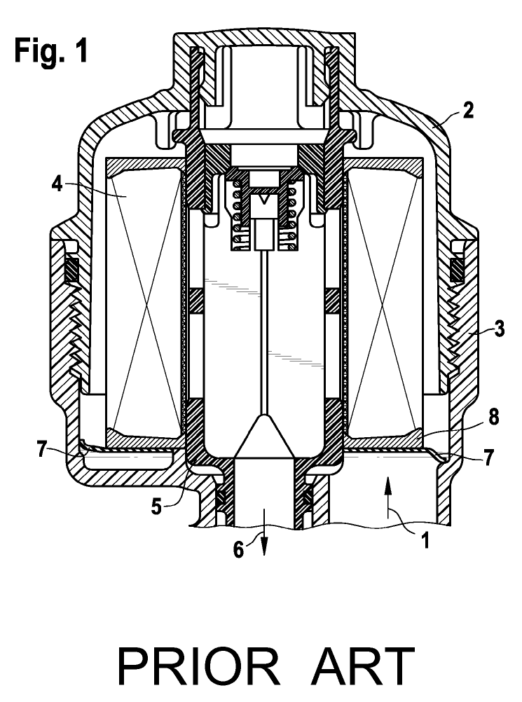

In FIG. 1, a filter arrangement is illustrated that corresponds in principle to the filter arrangement for fuel or lubricants for an internal combustion engine disclosed in prior art DE 100 46 494 A1. The unfiltered liquid to be filtered flows through inlet 1 into the filter housing that is comprised of a top part 2 and a bottom part 3. In the filter housing there is a filter element 4 of zigzag folded filter paper that is pushed onto a central tube 5 and is tightly damped when assembling the filter housing. The unfiltered liquid flows through the filter element 4 and exits at the filtered side through the central tube 5 and through the outlet 6.

A non-return diaphragm 7 is provided on an end plate 8 of the filter element 4 and is comprised e.g. of elastomer; this diaphragm releases the liquid flow at the unfiltered side but upon interruption of the flow, for example, upon shutdown of the internal combustion engine, prevents return flow into the inlet 1 by axial or radial contact of the diaphragm on the filter housing.

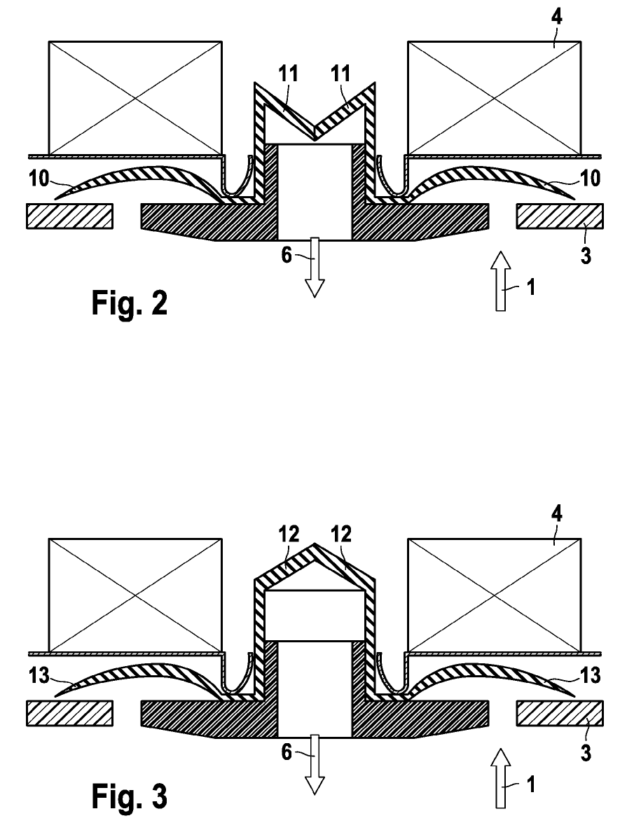

FIG. 2 shows a first embodiment of a beak valve 10 that is used in place of the non-return diaphragm of the prior art. Sealing flaps 11 of the beak valve 10 in the area of the outlet of the filtered liquid in the direction of the flow of the filtered liquid (arrow 6) are in an angled arrangement and an opening of the angled arrangement and thus of the beak valve 10 can be effected by the pressure of the flow of the filtered liquid.

In a further embodiment according to FIG. 3 the sealing flaps 12 of a beak valve 13 are angled counter to a direction of flow of the filtered liquid (arrow 6) and, during mounting, an opening of the angled arrangement and thus of the beak valve 13 can be effected by mechanical action of the filter housing 3 on which the filter element is arranged. The mechanical action can be effected in an advantageous way by a screw nipple secured on the bottom part of the filter housing 3 that pushes through (not illustrated) the sealing flaps 12 upon mounting and in this way erects the sealing flaps 12 in such a way that flow is not impaired. When removing the replaceable filter and, at the same time, removing the screw nipple so that the flexible sealing flaps are restored in their angled arrangement, the beak valve 13 will close again and prevent return of filtered liquid.

### INDUSTRIAL APPLICATION

The invention is commercially utilizable e.g. in filter arrangements for liquids, in particular for oil or fuel of an internal combustion engine for a passenger car or a truck or any other fuel-operated machine or as a water filter.

What is claimed is:

1.-6. (canceled)

7. A filter arrangement for liquids, the filter arrangement comprising:
a filter housing comprised of a bottom part and a top part;
a cylindrical filter element inserted axially into the filter housing;
at least one seal that, after assembly of the filter arrangement, effects closure of at least one return device for unfiltered liquid to be filtered;
wherein the at least one seal is a beak valve arranged in the filter housing, wherein the at least one seal prevents return of the unfiltered liquid as well as of filtered liquid of the filter element.

8. The filter arrangement according to claim 7, wherein the beak valve is an elastomer component having a first part and a second part, wherein the first part releases and inlet in an inlet direction of the unfiltered liquid, wherein the second part closes an outlet by an angled arrangement of sealing flaps of the beak valve in an outlet direction of the filtered liquid when the filter element is removed from the filter housing, and wherein the second part, when the filter arrangement is assembled, releases the outlet by mechanical action of the filter housing or by pressure of the filtered liquid.

9. The filter arrangement according to claim 8, wherein the sealing flaps are angled so as to point in a direction counter to the outlet direction of the filtered liquid and, when the filter arrangement is assembled, the angled arrangement and thus the beak valve is opened by mechanical action of the filter housing in which the filter element is arranged.

10. The filter arrangement according to claim 9, wherein the mechanical action is effected by a screw nipple that is secured on the bottom part of the filter housing, which screw nipple pushes through the sealing flaps during assembly.

11. The filter arrangement according to claim 8, wherein the sealing flaps are angled so as to point in the outlet direction of the filtered liquid and opening of the angled arrangement and of the beak valve is effected by pressure of the flow of the filtered liquid.

12. The filter arrangement according to claim 7, wherein the filter arrangement is a fuel filter or a lubricant filter for an internal combustion engine of a motor vehicle.
